(19) United States
(12) Patent Application Publication
(10) Pub. No.: US 2006/0128220 A1
(43) Pub. Date: Jun. 15, 2006

(54) Bus-line protector

(75) Inventors: Yu-Cheng Lin, Taipei City (TW); Yu-Jen Liang, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei (TW)

(21) Appl. No.: 11/216,060

(22) Filed: Sep. 1, 2005

(30) Foreign Application Priority Data
Dec. 10, 2004 (TW) 093219957

(51) Int. Cl. H01R 13/648

(52) U.S. Cl. 439/607

(57) ABSTRACT

A bus-line protector preventing the bus-lines within a computer casing from moving around and being damaged by metal components is disclosed. The bus-line protector has a base plate and at least one wing plate, wherein the base plate has at least one notch and at least one fold line. The wing plate is extended from the fold line of the base plate and comprises at least one insert extended from a periphery of the wing plate. After placing the bus-lines on the top surface of the base plate, the wing plate is inclined inwardly at the fold line and covers the base plate. Then, the insert comprising a T-shaped protrusion is securely engaged into the notch of the base plate. As a result, the bus-lines are fixed in location and are thus protected by the bus-line protector of the present invention.

### BACKGROUND OF THE INVENTION

1. Field of the Invention

The present invention relates to a bus-line protector, and more particularly, to a bus-line protector to protect the bus-lines within the case of a computer.

2. Description of Related Art

In the case of a computer, there are a lot of bus-lines connecting various computer components (such as a motherboard, a video card, or a hard disc device). Therefore, it is probable that some of the bus-lines are cluttered up inside the case of a computer.

As shown in FIG. 1, in order to connect the aforesaid computer components, the length of the bus-lines is usually longer than what it is actually needed. The conventional method to take care of the excess length of the bus-lines is to use a bus-line clip 11 to tie the bus-lines 12 up. Although the bus-line clip 11 can perform the said task, it cannot fix the position of the bus-lines and prevent the bus-lines from moving around inside the case of the computer. As a result, the excess length of the bus-lines would still interfere with other components inside the computer case and affect the efficiency of the computer.

Moreover, in the prior art, the bus-lines are neither covered nor protected by the bus-line clip. In other words, the bus-lines are still exposed to many sharp-edged metal components inside the case of the computer, such as the cooling fan, a rim of the case itself, and exposed tips of positioning screws. Therefore, when the computer is being operated, the non-covered, non-protected bus-lines may easily move around inside the case of the computer and become damaged by those sharp-edged components. Such elementary beginnings may soon lead to very serious consequences, such as loss of data, if the computer subsequently malfunctions.

### SUMMARY OF THE INVENTION

The object of the present invention to provide a bus-line protector, which keeps the bus-lines from being damaged by the other metal components within the case of a computer.

Another object of the present invention is to provide a bus-line protector that holds the position of the bus-lines and prevents them from moving around inside the case of a computer.

To achieve these objects of the present invention, the bus-line protector of the present invention mounted inside a computer case comprises a base plate comprising at least one notch, and at least one fold line extending from at least one side of the base plate, and; at least one wing plate extending from the at least one fold line of the base plate, and comprising at least one insert extended from at least one side edge of the corresponding wing plate except the side edge connected to the corresponding fold line of the base plate; wherein when the at least one wing plate is inclined at the corresponding fold line of the base plate and is folded relative to the base plate, the at least one insert is engaged into the at least one notch of the base plate for fixing a bus-line in location.

After placing the bus-lines on the top surface of the base plate, the wing plate is inclined inwardly relative to and covering the base plate. Then, the aforesaid insert is inserted into the corresponding notch of the base plate and is tightly secured therewith. As a result, the bus-lines are placed between the base plate and the wing plate and thus are protected from those sharp-edged components inside the case of a computer.

At this point, the bus-line protector of the present invention has covered and protected the bus-lines from being damaged, penetrated or scratched by the other metal components inside the case of a computer. Additionally, the bus-line protector of the present invention can also retain the bus-lines in position.

Furthermore, the base plate of the bus-line protector of the present invention can further comprise at least one hole and at least one fastening element extending into the hole to fasten the base plate to the case of a computer. The fastening element can be a screw, a plug, or a plastic clip. Additionally, the wing plate can further comprise at least one securing hole, and the securing hole has a diameter smaller than a diameter of a pillar protruded from the inner surface of the case of a computer. The base plate of the bus-line protector can further comprise at least one aperture corresponding to the bumps on the inner surface of the case of a computer.

The form of the securing hole of the wing plate is not limited, and preferably is a cross-notch, or a slotted configuration, wherein the securing hole is not only smaller in diameter than but also corresponding to the aforesaid protruding pillar located on the inner surface of the case of a computer. As a result, the wing plate can be fixed to the base plate, and can also cover the bus-lines. Furthermore, at least one protruding pillar has an internal screw, which enables other electrical components enclosed within the computer case to be placed over the bus-line protector and the position thereof to be fixed.

The shape of the notch of the present invention is not limited, but preferably the width of the notch at the center is wider than the width of the notch at the ends. The form of the fastening element of the present invention is not limited, but preferably is a screw, a plug, or a plastic clip. The composition of the insert of the present invention is not limited, but preferably the insert comprises a T-shaped protrusion. The form of the securing hole of the present invention is not limited, but preferably is the cross-notch, or a slotted configuration. The material of the base plate and the wing plate is not limited, but the base plate and the wing plate are preferably made of electrical insulation plates or thick cardboards, and more preferably Mylar™.

Additional features and advantages of the present invention will be set forth in part in the description which follows, and in part will be obvious from the description, or may be learned by practice of the present invention. The features and advantages of the present invention will be realized and attained by means of the elements and combinations particularly pointed out in the henceforth appended claims.

It is to be understood that both the foregoing general description and the following detailed description are exemplary and explanatory only and are not restrictive of the present invention, as claimed.

The accompanying drawings, which are incorporated in and constitute a part of this specification, illustrate several embodiments of the present invention and together with the description, serve to explain the principles of the present invention.

### BRIEF DESCRIPTION OF THE DRAWINGS

FIG. 1 is a schematic drawing of a conventional bus-line clipper;

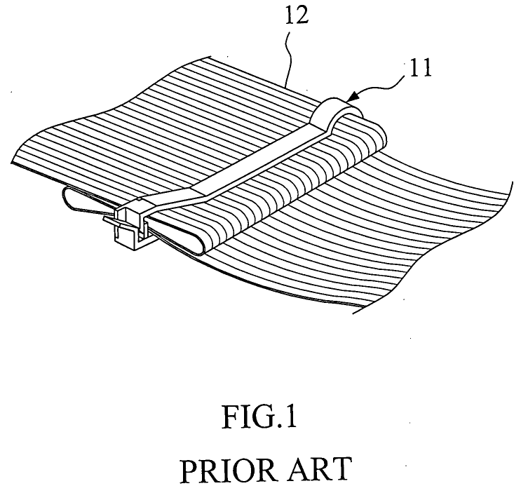

FIG. 2 is a schematic drawing of a bus-line protector of the present invention;

FIG. 3 is a schematic drawing showing the bus-line protector in the case of the computer before the bus-line protector being locked up, according to the present invention;

FIG. 4 is a schematic drawing showing the bus-line protector in the case of the computer when the bus-line protector is retained, according to the present invention.

### DETAILED DESCRIPTION OF THE PREFERRED EMBODIMENT

Reference will now be made in detail to present embodiments of the present invention, examples of which are illustrated in the accompanying drawings. Wherever possible, the same reference numbers will be used throughout the drawings to refer to the same or like parts.

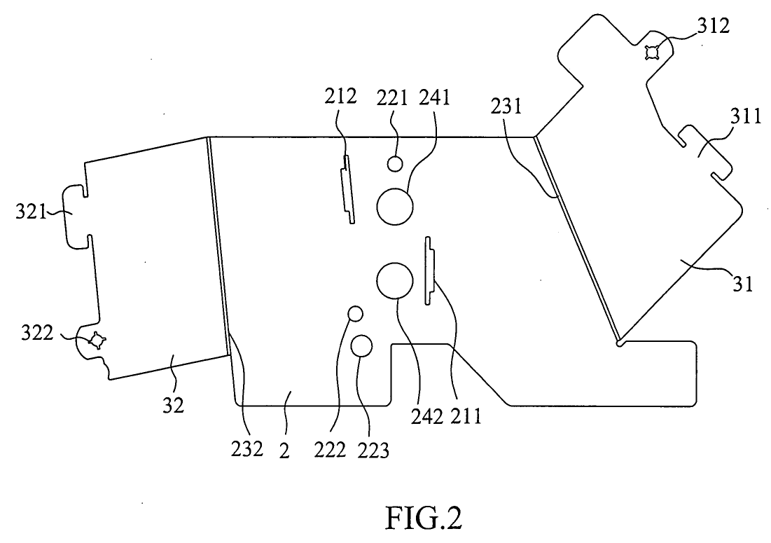

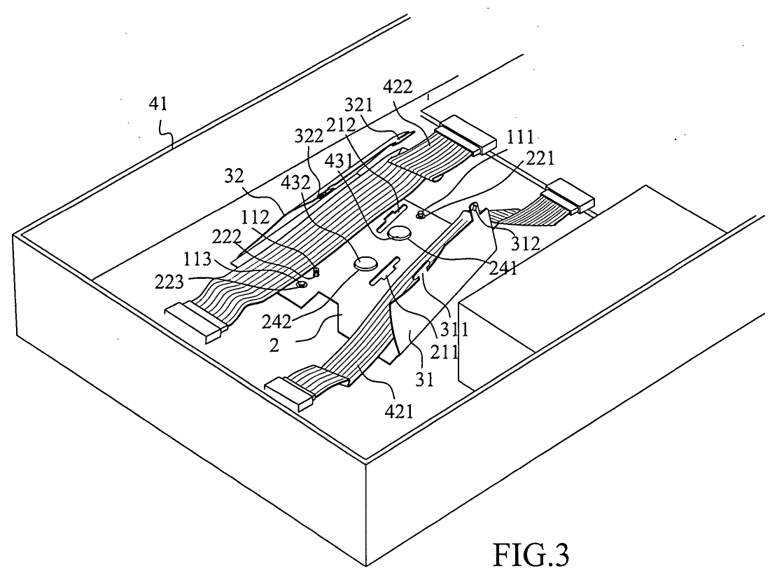

Referring to FIG. 2, the bus-line protector of the present invention comprises a base plate 2 and two wing plates 31, 32, which are made of Mylar™. On the base plate 2, there are two notches 211, 212, wherein the widths of the two notches 211, 212 at the center are both wider than the width at the ends thereof. Two fold lines 231, 232 are respectively formed at substantially opposed side edges of the base plate 2. Moreover, the base plate 2 has three holes 221, 222, 223 and two apertures 241, 242, wherein the two apertures 241, 242 correspond to two bumps 431, 432 on the inner surface of the computer case 41 (as shown in FIG. 3)

The two wing plates 31, 32 are extended from the fold lines 231, 232 of the base plate 2, respectively. At the ends of the wing plates 31, 32 opposing to the fold lines 231, 232, there are T-shaped protrusions 311, 321 and securing holes 312, 322, wherein each of the securing holes 312, 312 is configured as a cross-notch.

FIG. 3 is a schematic drawing showing the bus-line protector in the case of the computer before the bus-line protector being tightly closed according to the present invention. To assemble the bus-line protector of the present invention, the two holes 221, 222 are aligned with two protruding pillars 111, 112 located on the inner surface of the computer case 41, such that the protector is mounted over the pillars 111, 112. Then, a screw 113 is screwed into the hole 223, so as to secure the base plate 2 of the bus-line protector of the present invention to the computer case 41. When the bus-line protector is so secured, the two apertures 241, 242 are precisely and respectively mated over the corresponding bumps 431, 432 of the computer case 41.

Next, the bus-lines 421, 422 are placed on the top surface of the base 2 and the two wing plates 31, 32 are inclined inwardly and towards each other according to the fold lines 231, 232. Then, the T-shaped protrusions 311, 321 are respectively placed into the corresponding notches 211, 212 and the securing holes 312, 312 are aligned with the two protruding pillars 111, 112 located on the inner surface of the computer case 41, such that the wing plates 31, 32 are respectively secured to the pillars 111, 112.

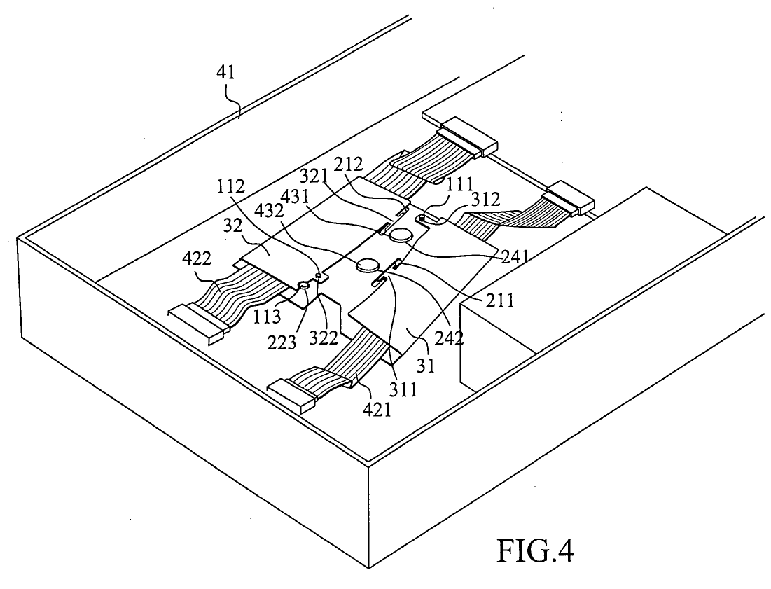

After the fixture of the two wing plates 31, 32, the bus-line protector according to the present invention is in its retaining position as shown in FIG. 4. Additionally, the two protruding pillars 111, 112 with internal screws and the two bumps 431, 432 located on the inner surface of the computer case 41 can be used to support and retain other electrical components enclosed within the computer case, such as a support frame of the cooling fan.

Therefore, the bus-line protector of the preferred embodiment not only keeps the bus-lines 421, 422 from being damaged by the other metal components enclosed within the computer case 41, but also prevents the bus-lines 421, 422 from moving around inside the computer case 41.

In the present invention, the base plate 2 can also be fixed to the computer case 41 without the use of the screw 113. It is to be noted that as long as the two wing plates are secured to the two protruding pillars 111, 112 via the holes 312, 322, the base plate 2 can abut the two protruding pillars 111, 112 of the computer case 41.

Other embodiments of the present invention will be apparent to those skilled in the art from consideration of the specification and practice of the present invention disclosed herein. It is intended that the specification and examples be considered as exemplary only, with a true scope and spirit of the present invention being indicated by the following claims.

What is claimed is:

1. A bus-line protector mounted inside a computer case, said bus-line protector comprises:
a base plate comprising at least one notch, and at least one fold line extending from at least one side of said base plate, and;
at least one wing plate correspondingly extending from said at least one fold line of said base plate, and comprising at least one insert extended from at least one side edge of said corresponding wing plate except the side edge connected to the corresponding fold line of said base plate;
wherein when said at least one wing plate is inclined at said corresponding fold line of said base plate and is folded relative to said base plate, said at least one insert is engaged into said at least one notch of said base plate for fixing a bus-line in location.

2. The bus-line protector of claim 1, wherein said at least one insert comprises a T-shaped protrusion.

3. The bus-line protector of claim 1, wherein the width of said at least one notch at the center is wider than the widths of said at least one notch at the ends.

4. The bus-line protector of claim 1, wherein said base plate further comprises at least one hole through which to fasten said base plate to said computer case by insertion of at least one fastening element correspondingly.

5. The bus-line protector of claim 4, wherein said at least one fastening element comprises a protruding pillar mounted on an inner surface of said computer case; said at least one hole of said base plate having a diameter smaller than a diameter of said corresponding protruding pillar.

6. The bus-line protector of claim 4, wherein said at least one wing plate further comprises at least one securing hole, said at least one securing hole having a diameter smaller than a diameter of said at least one fastening element; wherein said at least one wing plate is inclined relative to said base plate according to said corresponding fold line so that said at least one securing hole is press-fitted and fastened to said at least one fastening element.

7. The bus-line protector of claim 6, wherein said at least one securing hole comprises a cross-notch therein.

8. The bus-line protector of claim 1, wherein said base plate and said at least one wing plate are made of electrical insulation plates.
